(19) United States
(12) Patent Application Publication
(10) Pub. No.: US 2015/0283930 A1
(43) Pub. Date: Oct. 8, 2015

(54) TEMPORARY MOTOR VEHICLE SEAT COVER

(71) Applicant: Dean Dayton, Puyallup, WA (US)

(72) Inventor: Dean Dayton, Puyallup, WA (US)

(21) Appl. No.: 14/679,895

(22) Filed: Apr. 6, 2015

Related U.S. Application Data
(60) Provisional application No. 61/975,291, filed on Apr. 4, 2014.

(51) Int. Cl. B60N 2/60

(52) U.S. Cl. CPC B60N 2/60

(57) ABSTRACT

A temporary, motor vehicle seat cover includes a rectangular central panel made of flexible, machine washable material with a front leaf, two opposite side leaves and a headrest pocket on the central panel opposite the front leaf. The central panel includes a back region and a seat region. Attached or integrally formed with the front edge of the seat region is a transversely aligned front leaf configured to cover the seat's front edge and partially over the seat's front panel. The two side leaves are configured to cover the seat's top side edges and partially extend over the seat's side panels. Attached or integrally formed with the rear edge of the seat region is a transversely aligned headrest pocket. The headrest pocket is oriented and configured to extend around the top end and around the seat's headrest when the cover's back region and seat region are longitudinally aligned over the top surface of the seat. When not used, the seat cover may be folded into a compact configuration.

This utility patent application is based upon and claims the filing date benefit of U.S. provisional patent application (application Ser. No. 61/975,291) filed on Apr. 4, 2014.

The following patent document contains original material subject to copyright protection. The copyright owner has no objection to the facsimile or digital download reproduction of all or part of the patent document but otherwise reserves all copyrights.

### BACKGROUND OF THE INVENTION

1. Field of the Invention

This invention pertains to motor vehicle seat covers, and more particularly to seat covers designed to be temporarily installed over a motor vehicle seat to protect the contact areas on the seat when an individual enters, exits, and sits in a normal position on the seat.

2. Description of the Related Art

Driver's and passengers in motor vehicles often wear dirty pants or carry sharp objects in their pants pockets that can damage the seat in the motor vehicles when sitting on the seat. Dirt and sharp objects in the driver's or passenger's pants may rub against the outer side edge and front edge of the seat's bottom cushion and against the outside vertical side edge of the back rest when the driver or passengers enters and exits the motor vehicle.

Many parents place a towel or blanket on the seat to prevent mud and dirt on a child's clothing from contacting the seat. Unfortunately, such towels or blankets are not securely attached to the seat and move enabling the mud or dirt from the child.

Workers often store sharp tools, such as screw drivers, in their pant's rear pockets. When they sit in a motor vehicle seat with the sharp object in a pant's rear pocket, the sharp object can penetrate the bottom cushion or back rest.

What is needed is a lightweight, foldable temporary motor vehicle seat cover that quickly unfolded and easily installed over a motor vehicle's seat to protects the seat's bottom cushion, back rest, side edges and front edges. What is also needed is a seat cover that covers the exposed surfaces of the seat that contact the driver or passenger when the driver or passenger enters, or exits, or sits on the seat. What is also needed is a seat cover that conforms to different driver and passenger seats and temporarily drapes over and covers the contact areas on the bottom cushion and back rest. What is also needed is a seat cover that does not use clips, straps that connect to the seat or headrest. What is also needed is a seat cover the folds into a compact configuration for storage and is made of machine washable material.

### SUMMARY OF THE INVENTION

These and other objects of the present invention are met by a temporary, motor vehicle seat cover includes a rectangular central panel made of flexible, machine washable material configured to cover the seat's bottom cushion and the seat's back rest. The seat cover also includes a front leaf, two opposite side leaves and a headrest pocket. The front leaf is attached or integrally formed with the front edge of the seat region of the cover and configured to extend over the seat's front edge and partially over the seat's front panel. The two side leaves are configured to extend over and cover the bottom cushion's opposite top side edges and side walls.

The headrest pocket attached or integrally formed with the top edge of the cover's back region is configured to extend rearward and around the seat's headrest when the cover's back region and a seat region are longitudinally aligned over the back regions' front and the seat region's top surfaces, respectively. During installation, the central panel is draped over the seat and the headrest is extended over the headrest to hold the central panel in place over the seat. The weight of the driver or passenger presses the central panel against the seat and holds in place over the seat. The front leaf and the two side leaves also assist in holding the central panel in place over the seat. Because the two side leaves are symmetrically aligned on the central panel, the seat cover may be used on either the driver or passenger seat.

The seat cover is made of material sufficient flexible and rigid to automatically cover the seat when the headrest pocket is placed around the headrest. In one embodiment, the seat cover is made of thin, water absorbent cotton capable to being wash washable. In another embodiment, then sear cover may be made of thicker, puncture resistant material. In other embodiments, the seat cover may be a single layer or multiple layers. Because the headrest is axially aligned with the central panel and may be turned inside-out and because the two side leaves are symmetrical on the central panel both surfaces of the seat cover may be exposed, either surface of the cover may be exposed and used a contact surface with the driver or passenger.

When not used, the seat cover may be folded into a compact configuration for storage

### DESCRIPTION OF THE DRAWINGS

FIG. 1 is a side perspective view of a motor vehicle seat with a temporary seat cover installed over the sitting area on the seat.

FIG. 2 is a top plan view of the temporary seat cover.

FIG. 3 is a side elevational view of the temporary seat cover shown in FIG. 2.

FIG. 4 is a partial side elevational view of the central panel made of two layers of materials.

FIG. 5 is a front perspective view of the seat cover in a rolled up configuration.

### DESCRIPTION OF THE PREFERRED EMBODIMENT(S)

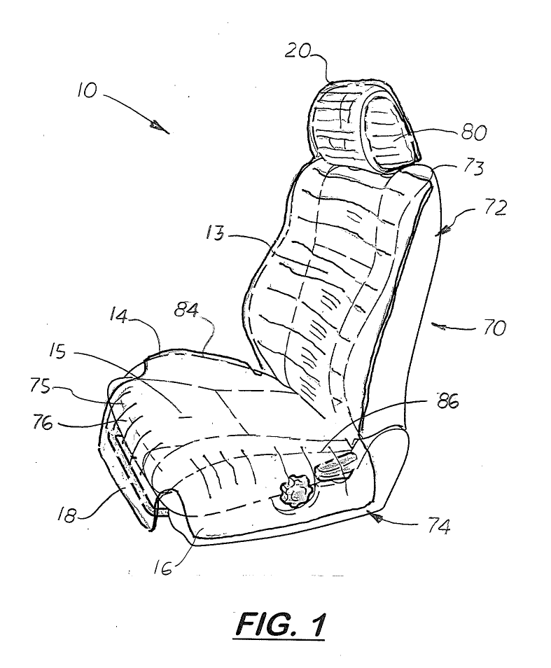

In the accompanying FIG. 1, there is shown a temporary, motor vehicle seat cover 10 installed over the top and front exposed surfaces of a motor vehicle seat 70 that includes an upright back rest 72, a substantially horizontal bottom cushion 74 and a headrest 80 that extends upward from the upper edge 73 of the rear back section 72.

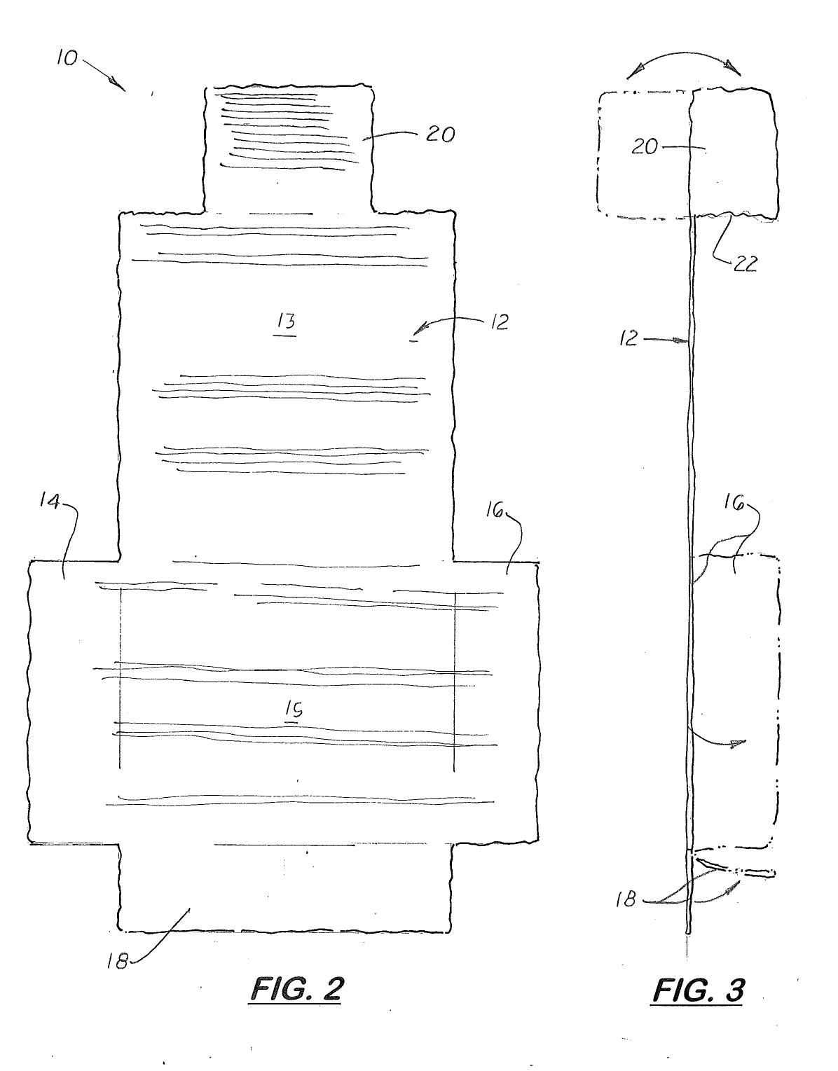

As shown more clearly in FIG. 2, the seat cover 10 includes a rectangular central panel 12 made of flexible, machine washable material with a transversely aligned rectangular front leaf 18, two opposite, longitudinally aligned rectangular side leaves 14, 16 and an axially aligned headrest pocket 20 opposite the front leaf 18. The central panel 12 includes a back rest region 13 and a seat region 15. The back rest region 13 and the seat region 15 are detached from the seat 70. Attached or integrally formed along the front section of the seat region 15 is a transversely aligned front leaf 18 configured to substantially cover the entire front edge 75 adjacent to the seat's front panel 76. The two side leaves 14, 16 are configured to cover seat's two side edges 84, 86 and side panels. When entering and exiting a seat, the driver or passenger rub their pants over the side edges 84, 86 making them most susceptible to dirt and punctures.

Attached or integrally formed with the top exposed edge of the back region 13 is a transversely aligned headrest pocket 20. As shown in FIG. 3, the headrest pocket 20 includes a wide opening 22 and is oriented rearward from the central panel 12 and configured to extend around the top end and around the seat's headrest 80 when the seat cover's back region 13 and a seat region 15 are longitudinally aligned over the top surfaces of the bottom cushion 74, the back rest 72 of the seat 50, respectively.

In the embodiment shown in the Figs, the overall length of the seat cover 10 is approximately 57 inches in length and approximately 36 inches in width. The headrest pocket 20 measures 12 inches in width and 9 inches in length. The side leaves 14, 16 measure approximately 6.5 inches in width and the 20 inches in length. The front leaf 18 measures approximately 24 inches in width and 6.5 inches in length. In one embodiment, the seat cover 10 is made of a continuous, single layer of material, such as cotton. The cotton may be 2 to 4 plies and weight 7 to 24 oz/yard

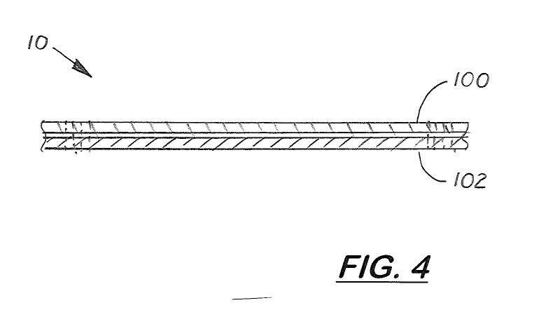

In a second embodiment, the seat cover 10 may be made of two or more layers 100, 110, as shown in FIG. 4 made of the same material or different materials. For example, the one layer 100 may be made of cotton and the second layer 110 may be made of a second layer of cotton or a layer of nylon or latex treated material that provides a water-proof barrier or is puncture resistant.

Also, in the embodiment shown in FIGS. 1-4, the back region 13, the side leaves 14, 16, the seat region 15, the front leaf 17, the headrest pocket 20 are integrally formed on the cover 10. It should be understood, that the side leaves 14, 16, the front leaf 17, and the headrest pocket 20 may be separately attached (via sewing or gluing).

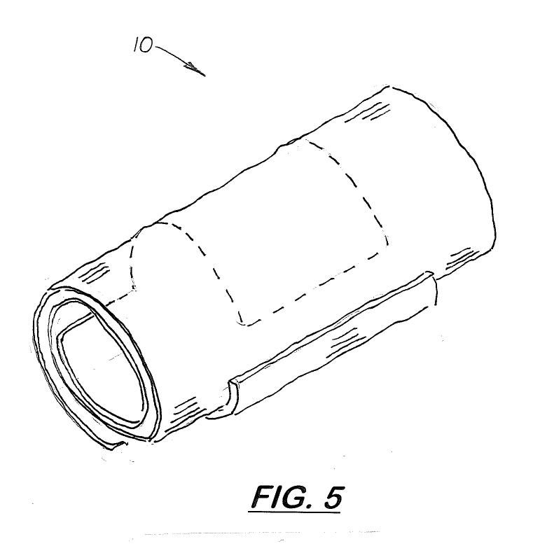

When not used, the seat cover 10 may be rolled (or folded, not shown) into a compact configuration as shown in FIG. 5.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A seat cover for a motor vehicle seat with a bottom cushion with two opposite side edges, and side walls, and an upward extending back rest, and an axially aligned headrest that extends upward from the rear back section, said seat cover comprising:
a rectangular central panel that includes a seat region configured to cover the top surface of the bottom cushion of a vehicle seat and an axially aligned back region that covers the front surface of the rear back section of a vehicle seat;
a front leaf extending transversely on said seat region configured to extend over and cover the front edge of the bottom cushion;
two side leaves extending longitudinally on opposite sides of said seat region and covered to cover the lateral side edges and a portion of the side walls on the bottom cushion; and,
a headrest pocket longitudinally aligned with said back rest, said headrest pocket configured to extend around and receive said headrest on the vehicle seat when said central panel is aligned axially over the bottom cushion and back rest of the vehicle seat.

2. The seat cover as recited in claim 1, wherein said central panel is made of single layer of cotton weighing 8 to 24 oz/yd.

3. The seat cover as recited in claim 1, wherein said central panel is made of multiple layers of cotton.

4. The seat cover as recited in claim 1, wherein said central panel is made of at least one layer of cotton and a section layer made of water-proof material or puncture resistant material.
